(19) United States
(12) Patent Application Publication
(10) Pub. No.: US 2017/0132674 A1
(43) Pub. Date: May 11, 2017

(54) DIRECT CAUSE MARKETING CALL TO ACTION REOCCURRING FUNDRAISING METHOD AND SYSTEM

(71) Applicant: Cups Help, LLC, Nashville, TN (US)

(72) Inventors: Michael Patrick Sohr, Nashville, TN (US); Thomas Woodard, Nashville, TN (US)

(21) Appl. No.: 15/348,857

(22) Filed: Nov. 10, 2016

Related U.S. Application Data
(60) Provisional application No. 62/285,833, filed on Nov. 10, 2015.

(51) Int. Cl. G06Q 30/02

(52) U.S. Cl. CPC G06Q 30/0279

(57) ABSTRACT

The present invention is a fundraising method and system wherein a refillable vessel containing machine readable information is employed to collect funds for a beneficiary upon refilling the refillable vessel at a retail establishment.

### CROSS REFERENCE TO RELATED APPLICATIONS

This non-provisional patent application claims priority to U.S. Provisional Patent Application No. 62/285,833, which was filed on Nov. 10, 2015.

### BACKGROUND OF THE INVENTION

There exists a need for an effective, consumer friendly and emotionally rewarding method and system for loyalty and cause marketing involving consumers and retail merchants. Because of built-in barriers to customer loyalty and fundraising programs that require customers to fill out a lengthy written application, download mobile applications and/or register in-store, overall consumer participation and interest is often limited. When a consumer does join a loyalty and fundraising programs they often decide the value does not justify the effort to engage with the merchant, due to the additional steps required to benefit and/or help raise funds for their chosen beneficiary. Additionally, these conventional loyalty and fundraising programs are typically costly to integrate with point of sale systems and back office systems (hereinafter “POS” and “BOS”), are difficult to administer, implement and/or maintain.

Other known methods exist for raising funds, wherein the beneficiary can direct where funds are spent. This is often accomplished by soliciting direct monetary donations by members of the beneficiaries organization and by non-members who support the goals and programs of such organizations. The beneficiary can be, but is not limited to a fundraising organization, corporate sponsor, a charity, a non-profit, a youth group or organization, a school or a group or entity for which funds are raised for the benefit of the group or entity. Another common approach is the solicitation of goods, services and cash donations from retailer merchants, corporations, businesses, and vendors. After the good are donated to the charity, the goods and services are often sold, raffled, or given away as door prizes at social events and functions of the organizations, at which nominal donations are requested for admission. Generally, the motive of the donating parties, although seldom effective, is the creation of goodwill among the members of the organization and others who might then be more likely to patronize their store or purchase the store's products.

Most businesses whether retail or corporate recognize the growing importance of cause marketing amongst the growing population and buying power of the millennial consumers, who will soon out number and out spend the baby boomers. Businesses understand that millennials often choose to engage with brands that are socially responsible, and therefore business is continually trying to improve sales by increasing market share from millennials. However, brands often fail in their efforts because brands often dictate their cause marketing to the consumer, which may not be appealing or of value to the consumer. Although, brands often try to be socially responsible by raising money for particular causes, attempts at social responsibility can end up hurting the brand's business because the consumer my feel pressure or guilt to have to donate. This can lead to the consumer choosing to avoid engaging with the brand in the future.

U.S. Pat. No. 8,732,092 (“Rourke”), describes a fundraising method and system. Rourke uses a discount card to bring a charity, a consumer, and a retail merchant together. Rourke states that the discount card “frees the benefiting organization from having to sell merchandise that is often perceived as being overpriced or is perceived as unwanted for the purpose of supporting the organization”. Rourke further describes the discount cards as “it should be understood that the term “card” can have a large variety of embodiments including, but not limited to plastic credit card size, a scanable key chain card, a card, coupon, or paper with a specific serial number, and the like. Preferably the card is of the plastic credit card shape so as to be easily identified by the user, be resilient, and allow the storage and/or transmittal of data”. The discount card in Rourke is a non-functional entity other than as an information transmitter and identifier.

U.S. Pat. No. 7,934,661 (“Nichols”) describes a marketing/fundraising/reward system and method. The system and method disclosed in Nichols employs the data handling and gathering described by Rourke but uses an authenticity tag. The authenticity tag is typically printed on cloth and affixed onto a product. The product is described as apparel i.e., shirt or a flag i.e., funeral car flag. Nichols discloses providing customers with a readily visible, exposed identifier which is affixed to a purchased apparel product as the vehicle to bring all parties, i.e., cause, consumer, and retail merchant together. This process is cumbersome as it places the burden of affixing the authenticity tag on the consumer.

U.S. Pat. No. 8,756.102 (“Tietzen”) discloses that analytics are a very important element for success of any cause-marketing program. Simplicity and transparency are key requirements for such analytics to be appreciated and accepted. The method disclosed in Tietzen is bulky and costly for the merchant due to the required POS and BOS integration and lacks transparency for the consumer because every merchant value is different.

U.S. Published Application No. 2014/0052523 A1 (“Adams”) titled “System and method for mutually promoting fundraising organizations and merchants” discloses receiving an indication that a merchant-associated tag was scanned by a tag reader via a processor-based device at a merchant location; validating the merchant-associated tag and scanning event; and providing an incentive to a beneficiary based at least in part on the validation of the merchant-associated tag and scanning event. Adams discloses the importance of incentivizing the consumer to engage with a merchant through the use of advertising on a mobile device and then being able to track whether the advertising worked by validating when a consumer scans a tag. However, Adam's focus on consumer engagement with the merchant to reward fundraising organizations whether or not the consumer makes a purchase is not sustainable or scalable.

U.S. Published Patent Application No. 2015/0081463 A1 (“Horton”) discloses a system and method for fundraising and charitable giving at a point of sale. Horton describes the steps of a customer selecting a product from a store shelf; the customer removing a fundraising tag from the product; the customer completing the information on the fundraising tag, which can include designating an organization to benefit from the fundraising; and a retailer processing the fundraising tag after receiving the completed tag from the customer at the point of sale. Horton disclose the required analytics to insure that all necessary information is gathered through the use of a store shelf item as the vehicle to bring the charity, customer, and merchant retailer together. Unfortunately, the Horton process is cumbersome, time consuming and places undue responsibility on the consumer and the merchant retailer.

### SUMMARY OF THE INVENTION

The present application is an improved and surprisingly effective method and system for engaging in loyalty and fundraising programs. The beneficiary can first realizes funds from the initial sale of the refill vessel (“RV”) and subsequently realizes recurring funds raised every time a RV refill is purchased at any registered retail refill partner (hereinafter “RRRP”). The consumer purchases a RV to support their beneficiary and then every time they refill at a RRRP a percentage of each refill sale is set-aside for the beneficiary. This is a simple and transparent consumer driven product based recurring fundraising program that creates value for all parties without additional steps for the beneficiary, consumer or RRRP. It is common for a consumer to patronize a retail merchant that supports their beneficiary and by doing so they become a loyalty customer, and often one with an emotional attachment to the retail merchant. The customer will then often prefer to transact with the retail merchant rather than its competitors that do not support the customer's beneficiary.

The following definitions will be used to described embodiments of the present invention. The following definitions are not limiting, but provide explanation to the embodiments of the present invention.

The refill program is the process by which a consumer engages with a RRRP by refilling their vessel through that RRRP and paying a set fee for the purchase of such refill. The RRRP identifies at the point of sale that the refill is part of the professional third party's program and sets aside a percentage of the refill purchase (or percentage of the set fee) to be sent to the provider or professional third party who distributes said funds to the beneficiary who is associated with that refill vessel.

The provider, also referred to herein as the professional third party (or “PTP”) is the provider and manager of the refill program. The PTP manages all aspect of the program, including, but not limited to supplying the RV, marketing materials to all participating RRRPs, beneficiaries, corporate partners, collection, and distribution of funds.

The beneficiary is a fundraising organization, corporate sponsor, a charity, a non-profit, a youth group or organization, a school or a group or entity for which funds are raised for the benefit of the group or entity. Examples of a beneficiary can include, but not limited to, schools, Rotary clubs, Kiwanis clubs, Jaycees, Masons, Catholic charities, United Jewish Communities, college alumni associations, national fraternities and sororities, American Association of Retired Persons, credit and trade unions, military organizations, state government foundations, religious institutions, scouting organizations, youth sports organizations and/or teams, corporate human resources departments, foundations, other ethnic or religious organizations, and other organizations interested in raising funds.

The consumer is the individual that obtains the refillable vessel for the purpose of supporting a known beneficiary. The consumer is any person that refills a vessel (RV) that is identified at the point of sale to be part of the professional third party's (provider's) program supporting a beneficiary.

The registered retail refill partner or “RRRP” is a retail establishment or store that contracts with the provider also known as the professional third party to refill the refillable vessel for the consumer. Examples of retail stores or establishments within the scope of the present invention include, but are not limited to, convenience stores (e.g., 7-11, Circle K, WaWa), gas stations, fast food restaurants, delicatessens, food kiosks, and the like.

The vendor is a supplier/distributor to the registered refill partner that provides product for their retail establishment. In certain embodiments of the invention the vendor can supply the refillable item at a reduced cost, no cost or for some other compensation to be determined. The vendor can also pay for the costs of the provider or professional third party to manage the refill program.

The consumer product goods company (or “CPG”) are companies that sell CPGs. Consumer packaged goods (CPG) are a type of goods consumed every day by the average consumer. The goods that comprise this category are ones that need to be replaced frequently, compared to those that are usable for extended periods of time. Non-limiting examples of CPG's are Coca Cola, Heinz, Pepsi Co, Proctor & Gamble, Unilever, Nestle, 3M, Anheuser-Busch InBev, and/or Oscar Meyer. In certain embodiments of the present invention the consumer product goods company can supply the refillable item at a reduced cost, no cost or for some other compensation to be determined. The consumer product goods company can also pay for the costs of the provider or professional third party to manage the refill program.

The refillable vessel or RV is any vessel that is refillable at a RRRP. The RV is identified at the point of sale to be part of the professional third party's program supporting a beneficiary. The RV can be filled with liquids or solids. The fillable item can be a beverage, food, or a non-consumable item. The refillable item can be hot, cold, or room temperature. The RV can be specifically designed based on a pre-determined refillable item. For example, if the RV is designed to hold hot or cold beverages it can be designed to have insulated properties that keep the refillable item hot or cold. In one embodiment of the present invention the RV is designed to hold hot beverages, and the lid of the RV is capable of changing colors based on the temperature of the refillable item. For example the lid can be blue for cold items and red for hot items. The color and/or temperature variations can be determined when designing the RV.

The refillable item is the product that is supplied to the RV. A simple example is that a RV designed to hold beverages can be filled by liquids at the RRRP. An example of the liquid or refillable item can be a soft drink. The refillable item is not limited to food or beverages and can include non-consumable items.

The set fee for the refill (set fee) is the total price charged by the RRRP to the consumer at the point of service for the refill of the RV. The set fee includes both the fee the RRRP charges for the refill and the funds for the beneficiary associated with the refill.

The machine-readable label contains information that is readable at the point of service at the RRRF. The machine readable label contains a unique identification code in the form of, but is not limited to, a UPC, which is a universal product code, or an EAN, which is European numbering. A UPC/EAN is a unique number assigned to a RV that identifies, at the point of purchase the consumer, the purchase, and that the RV is part of the professional third party's refill program. The information on the machine-readable label is unique to each beneficiary.

A basket size is the total purchase by the consumer at the time of purchase of the RV refill. If the consumer purchases more than just the refill, the total basket will include the refill plus the additional items.

The present invention is an improvement on the known methods and processes and creates an improved product employing direct cause marketing, with a recurring fundraising method and system, which provides the following elements and their associated values and benefits.

The present invention allows the loyalty and fundraising program to be managed by a provider, such as a profession third party (or “PTP”), wherein the PTP can be, but is not limited to, a registered retail refill partner (“RRRP”), consumer product group (“CPG”), vendor, and/or the beneficiary.

The present invention provides a) unified coordination; (b) built-in fraud protection; (c) eliminates administrative burden from beneficiary; (d) enables scalability of program; and (e) a universal reporting system.

The present invention provides the following advantages: (a) scalable program; (b) ease of implementation; c) UPC/EAN tracked eliminating costly POS integration; d) UPC/EAN accepted by most retail merchant POS systems; (e) fraud prevention f) no barrier to entry; g) ease of participation; h) consistency and transparency; i) built-in fraud protection; j) vendor/CPG program participation; k) no additional inventory requirements; l) no barriers to who can participate.

Additionally, the present invention provides an open book policy to the accounting/reporting of the refill program, which provides transparency, fraud prevention and a simplified audit verification.

The present invention provides: a) RRRP inventory and margin control of dispensed beverages; b) quality control of program; c) fraud prevention; d) quality control of RV; e) reduced liability; f) scalability of program; g) control of product warranty and product replacement; h) control of manufacturing, supply and delivery; i) automobile cup holder compatible; j) upsell opportunity of customer from point of entry to point of sale; k) cost control; and; l) product design control.

The present invention provides the ability to modify the design of the RV, for example the printing or engraving on the RV. This allows for quality control, customization control, fraud protection, brand control, control of product warranty and product replacement, control of manufacturing, supply and delivery, and cost control.

A further benefit of the present invention is the gamification, or incentivizing of all parties, which can create productive competition between volunteers, corporate sponsors, beneficiaries, schools, students, RRRP's and fundraising organizations. The present invention further provides gamification with regard to reward and scholarship programs, increased participation, increased RRRP in-store sales, increased donations, CPG and vendor sponsorship, and increased awareness of the refill programs.

Additionally, a consumer driven program provides the following advantages: increased participation; emotional consumer loyalty towards the RRRP; empowers consumers to give to charities; increases store sales for RRRP's; creates increased awareness of the beneficiaries; scalability, and has no geographic limitations.

Further, refill fundraising programs according to the present invention provide: recurring donations; a consumer call to action; no risk to RRRP loyalty programs; increased store traffic; refill variety locations; vendor/supplier joint programs; no in-store inventory; no required integration beyond the UPC/EAN sticker/label; transparency and consistency; variety of refillable beverages; and no barriers to who can participate.

### BRIEF DESCRIPTION OF DRAWINGS

FIG. 1 illustrates a flow diagram of the registration of a beneficiary and engagement of the consumer in accordance with the present invention.

FIG. 2 illustrates a flow diagram of the registration of a retail merchant in accordance with the present invention.

FIG. 3 illustrates a flow diagram of consumer engagement with an RRRP, including tracking and disbursement of funds in accordance with the present invention.

### DETAILED DESCRIPTION OF THE INVENTION

Systems and methods for mutually promoting fundraising organizations, corporate sponsors, charities, non-profits, youth groups or organizations, schools or groups or entities for which funds are raised for the benefit of the group or entity (beneficiary), registered retail refill partners (RRRP), retail vendors (vendor) and consumer product goods companies (CPG) are described herein.

The refillable vessel or RV can be any type of container for holding liquids. The liquids can be hot or cold depending on the design of the RV. The RV can be semi-disposable or disposable.

In embodiments of the present invention, the provider contracts with the a beneficiary to provide the promotional materials, literature explaining the program, consent forms, order forms, and expertise, for the recurring refill fundraising program or “refill program”, which employs a refill vessel (RV) with a machine readable label.

In an alternate embodiment, the beneficiary can contract to purchase the RV from the provider at a predetermined price.

In a further embodiment a third party other than the provider can supply the RV to the consumer. Examples of non-provider third parties supplying the RV can be selected from, but are not limited to professional sports team, employers, restaurant chains, airlines, or any organization seeking to benefit a charity. The non-provider third party can add a machine readable label, such as a UPC/EAN code on their RV. The non-provider third party can distribute the RV at a concession stand (such as at a sports stadium) or from the check-out of a fast food restaurant/stand. The RV can be, as a non-limiting example, a semi-disposable cup, thereby enabling the fans or restaurant attendee to go to a RRRF with the RV and refill it to support the charity/beneficiary chosen by the non-provider third party.

The information on the RV may appear in the form of, but is not limited to, a barcode, a magnetic strip, or any other recognized means. Preferably, the information is machine readable and located on a label applied to the RV. The provider and/or representatives, supporters, volunteers, partners and or sponsors of the beneficiary presell, sell, purchase, give-away, barter and/or distribute the RV to interested parties. When the consumer purchases RV refills at a registered retail refill partner (RRRP), the RV is read in a similar manner as an in-store product, such as a computer based reader, or bar code scanner, which is in communication with the RRRP's point of sale system. The consumer is then charged a set fee for the refill purchased. The amount of the charge can be predetermined or can be increased by the customer. A percentage of each refill purchase can then be set aside by the RRRP. Subsequently, the amount set aside by the retail store (RRRP) is paid to the provider whereupon the provider pays each beneficiary an amount based upon the number of RV refills purchased with their unique identification code (e.g., UPC/EAN code). The payments can be made on a periodic basis or at predetermined intervals.

In an embodiment of the present invention the beneficiary will presell, sell, purchase, give-away, barter and/or distribute RVs. The price of the RV, if any, can be varied depending on the goals of the beneficiary. In certain embodiments of the present invention the beneficiary retains 100% of the profits generated from the sale of each RV. Variations on the split of the profits between beneficiary, RRRP, CTP, and/or other party are within the scope of the present invention.

In another embodiments of the present invention, the interest of the beneficiaries, and RRRPs can be mutually promoted. The provider can register one or more beneficiaries and one or more RRRPs to participate in the refill program. The beneficiary presells, sells, purchases, gives-away, barters and/or distributes RVs to beneficiary supporters, members of the beneficiaries organization, non-members of the beneficiaries organization who support the goals and programs of the beneficiary, and/or other potential participants. Consumers can patronize RRRPs with their RV's anywhere, such as locally, regionally, nationally or internationally, in order to purchase, on a regular or irregular basis, a RV refills. At the time of purchase the RRRP's point of service reads the RV, in a manner similar to any other in-store product, and the RRRP sets aside a percentage of each RV refill purchase (funds for the beneficiary), which is subsequently delivered to the provider. The payment to the provider can be periodic or at another predetermined interval.

The funds paid to the provider by the RRRP can be accompanied by a report (the RRRP report) providing information, including but not limited to, time period, date of purchase, time of day of purchase, store location of purchase, total number of RV refill purchases, total number of RV refills per unique UPC/EAN(s), and total basket size associated with each RV refill purchase. The provider then distributes funds to each beneficiary based on the total number of RV refills associated with the beneficiary's unique machine readable label from all RRRP locations. The distributed funds to the beneficiary will be accompanied by a report (the provider report) containing information, including, but not limited to, total refills of their unique RVs, total refills and donations per location, time of day of purchase, date of purchase, total refills associated with each fundraising partner, e.g., a school, corporate sponsor and or organization. The refill program, described herein, is scalable on a global scale because it is a simple straightforward reusable product based program that is not restricted by technology or geography. Furthermore, the present invention is sustainable because of its transparency, low cost, ease of implementation and participation, and because the program mutually benefits all parties involved.

In another embodiments of the present invention, the consumer can go to the website of the provider, the beneficiary, any third party partner, and/or the RRRP, and the consumer can customize the design of their own RV. The consumer can pick the style and size of the RV, as well as a design to be applied to the RV. The design can be any printed, engraved, or individually upload image which the consumer chooses to have on the RV. The design can be directly related to the organization and/or beneficiary the consumer chooses to support, or it can be an unrelated design.

In other embodiments of the present invention, the sizes of the RV may be different for hot and cold beverages (or based on other differences in the refillable item). The price of the refill can vary in view of the size of the RV and whether the RV is to be used for hot or cold beverages.

In another embodiments of the present invention, the consumer can purchase and or receive from the beneficiary, the provider, the RRRP, vendor, and/or CPG a permanent machine relabeled label, or UPC/EAN label (which can be in the form of sticker) for a unique beneficiary. The machine relabeled label is then applied to an existing container which now becomes the consumer's RV.

In another embodiment of the present invention, the consumer can receive a new machine readable label, such as a UPC/EAN sticker to be applied to an existing RV to replace a damaged, altered, or otherwise unreadable UPC/EAN. Additionally, the consumer can purchase one or more machine readable labels, or UPC/EAN stickers and distribute the sticker/label to friends, family, or other individuals or new consumer to adhere to a container to create a RV allowing the new consumer to patronize a RRRP in the new consumer's locality to support the beneficiary identified on the machine readable label.

In additional embodiments of the present invention the vendor and/or the consumer product goods company can supply the refillable item at a reduced cost, no cost or for some other compensation to be determined. The vendor and/or the consumer product goods company can also pay for the costs of the professional third party to manage the refill program. This can reduce and/or eliminate all costs to the RRRP, the provider and/or the beneficiary for administration of the refill program.

In another embodiments of the present invention, the provider can contract with the RRRP, vendor and/or consumer product goods company (“CPG”) to include with the shipping of the RV one or more of the following, but not limited to, coupons, promotions, a survey, list of services, a menu, and/or anything else the RRRP, vendor and or CPG would like to communicate or advertise to the consumer.

In another embodiments of the present invention, the RRRP, vendor and or CPG can bundle one or more additional products to the purchase of a RV refill whereby if a consumer purchases a RV refill in conjunction with an additional product the consumer may receive a discount on the purchase of the additional product and/or the RV refill, be entered into a contest, and/or the beneficiary may receive an additional donation from the purchase of the additional product.

In another embodiments of the present invention, the RV may have one or more machine readable labels, such as UPCs/EANs, whereby the RRRP reads the first machine readable label or UPC/EAN for the purchase of the refill, and in addition, during checkout the consumer may donate additional funds by having the RRRP scan the additional machine readable label or UPC/EAN and provide the RRRP the amount of an additional donation. In an alternate embodiment, the original UPC/EAN can be scanned more than one time and the consumer can inform the RRRP how much additional funds the consumer wants to donate. This allows the consumer to be in control of how much they want to donate to the beneficiary when patronizing a RRRP.

In another embodiments of the present invention, the RV's machine readable label or UPC/EAN may not have a predetermined set fee, which will allow the consumer to set any price they choose to pay for the refill above the RRRP's minimum required price. Any amount paid above the minimum purchase price would be a donation to the consumer's chosen beneficiary, as designated by the information on the machine readable label. This allows the consumer to be in control of how much they want to donate to the beneficiary when patronizing a RRRP.

In another embodiments of the present invention, the consumer may choose to use a card with a machine readable label, or apply a permanent machine readable label or UPC/EAN sticker to an item the consumer carries on their person (personal item). The consumer would refill their container and then use their card or personal item (either of which will not have the machine readable label) at the point of service to scan their RV refill purchase. The personal item can be refillable vessel, an attachment for a key chain, a phone, an identification card, or any easily transportable item the consumer chooses to carry. This further incentivizes the consumer to patronize the RRRP by giving the consumer flexibility to use any vessel to purchase their refill and still donate to their beneficiary.

In another embodiments of the present invention, the consumer can use a barcode within a mobile app or RFID device ((radio frequency identification) is a technology that incorporates the use of electromagnetic or electrostatic coupling, in the radio frequency (RF) portion of the electromagnetic spectrum to uniquely identify an object, animal, or person) when purchasing a refill rather than have the machine readable label or UPC/EAN on the RV vessel. The consumer refills their container and then uses their card, phone or RFID device at the point of service to scan their RV refill purchase. The consumer refills their container using their phone or RFID device at the point of service of the RRRP to scan and identify the refill purchase for the refill program. This further incentivizes the consumer to patronize the RRRP by giving the consumer flexibility to use any container to purchase their refill and still donate to their beneficiary.

In another embodiments of the present invention, the provider (or PTP) manages the program for all parties. The provider, also known as the professional third party, acts as a third party program manager. The provider is able to alleviate or eliminate from the beneficiary and/or RRRP administrative demands and/or costs of managing the refill program. Additionally, having a third party manager orchestrate all aspects of the refill programs creates a closed loop system providing transparency, quality control, consistency and scalability of the program. Furthermore, the third party manager minimizes and helps eliminate fraud from outside parties.

In another embodiments of the present invention, the refill program provides the RRRP the opportunity to upsell the consumer when the consumer enters the store. The RRRP can target the participating consumer because they will be carrying their RV enabling the employee to upsell or inform the customer of exclusive specials. The RRRP can strategically display in-store specials exclusive to refill program customer. This is a unique differentiator and a distinct advantage of the RV refill program of the present invention. The RRRP can optimize the consumer experience from point of entry through and beyond point of purchase. In contrast, other fundraising programs customers cannot be recognized until the point of purchase.

In another embodiments of the present invention, the provider can contract with the RRRP whereby once the RRRP realizes a certain increase in sales volume related to the RV refill purchases within a given time period (including, but not limited to hourly, daily, monthly, yearly, or lifetime) the RRRP can sets aside a percentage of each total basket sales that is part of a RV refill purchase. The predetermined increase can be based on sales exceeding a mutually agreed sales volume for a given period or total number of sales. The funds are subsequently delivered to the provider on a periodic basis (or at other predetermined intervals). The funds paid to the provider by the RRRP can be accompanied by a RRRP report providing information including, but not limited to, time period, date of purchase, time of day store location, total number of RV refill purchases, total number of RV refills per unique UPC/EAN, customer identity, and/or total basket size associated with each RV refill purchase. The provider subsequently distributes funds to the beneficiary (or beneficiaries) based on the total number of RV refills from all RRRP locations with the beneficiary's unique identification code in addition to a percentage of total sales associated with the unique RV refills. The distributed funds to the beneficiary can be accompanied by a provider report which includes information including, but not limited to, total refills, donations to the unique RVs, total refills and donations per location, total percentage of overall sales associated with the unique RVs, time of day of purchase, identity of consumer, date of purchase, and/or total refills associated with each fundraising partner (e.g. a school, corporation and/or organization).

In another embodiments of the present invention, the beneficiary can partner with a school whereby students presell the RV to supporters of their school and/or beneficiary partner. The student can be eligible to earn service hours, credit, or other rewards, for the students time selling the RVs. Additionally, the students will be able to track, via a website, the total amount of donations generated based on the initial sales of the RVs and the percentage of donations generated through RV refill purchases. The beneficiary and the partnering organization can negotiate on a case by case basis how the proceeds for the initial sales of the RVs and the proceeds from the RV refills are to be divided between the partners.

### EXAMPLES

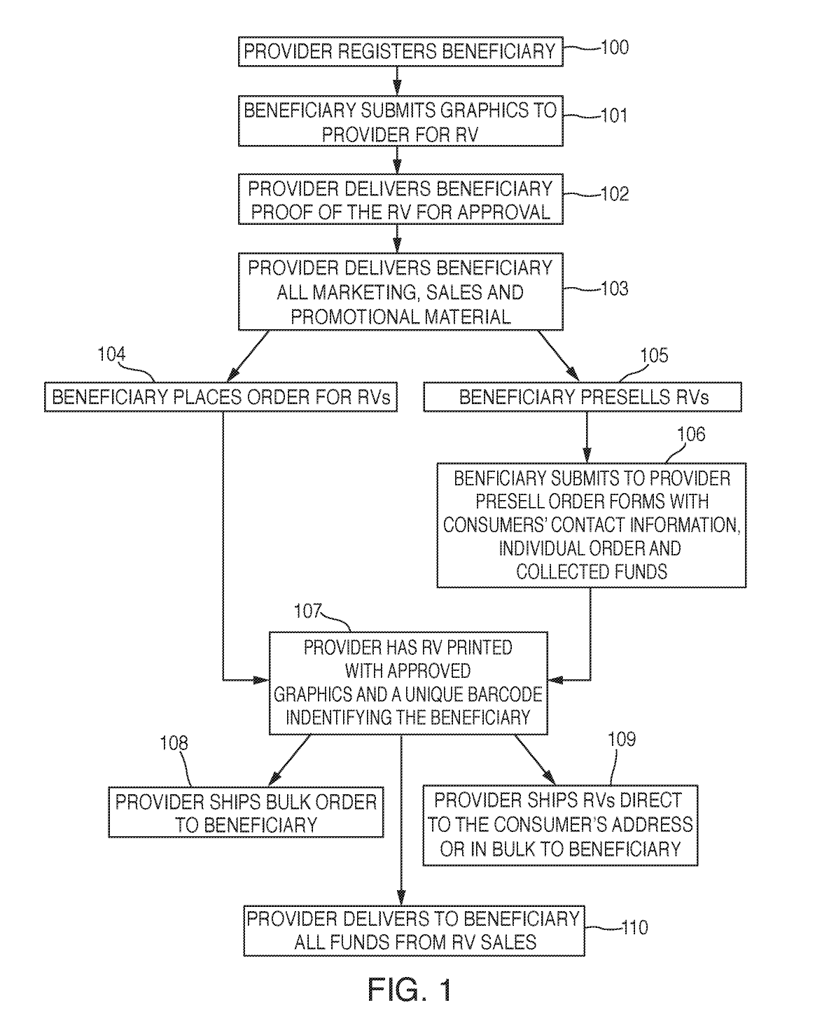

An embodiment of the present invention as described in FIG. 1 provides the following steps describing the registration of a beneficiary and the engagement of the consumer in accordance with the present invention: provider registers beneficiary (100); beneficiary submits graphics to provider for RV (101); provider delivers beneficiary proof of the RV for approval (102); provider delivers beneficiary marketing, sales and promotional materials (103).

Next, the beneficiary can place orders for the RV's (104), or the beneficiary can presell the RV (105), followed by the beneficiary submitting information to provider such as pre-order forms with consumer contact information, individual orders and the collected fund (106).

Next, the provider will have the RV printed with approved graphics and a unique barcode (UPC/EAN) identifying the beneficiary (107). Subsequently, the provider ships bulk orders to the beneficiary (108), the provider ships RV's direct to the consumer (109), and/or the provider delivers all funds from RV sales to the beneficiary (110).

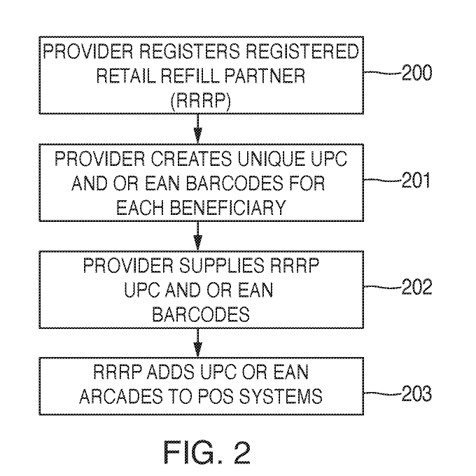

An embodiment of the present invention as described in FIG. 2 provides the following steps describing the registration of a retail merchant (RRRP) in accordance with the present invention: provider certifies a registered retail re-fill partner (RRRP) (200); the provider creates a unique UPC and/or EAN barcode for each beneficiary (201); the provider supplies RRRP UPC and/or EAN barcodes (202); and the RRRP adds the UPC or EAN barcodes to the RRRP's point of service (POS) systems (203).

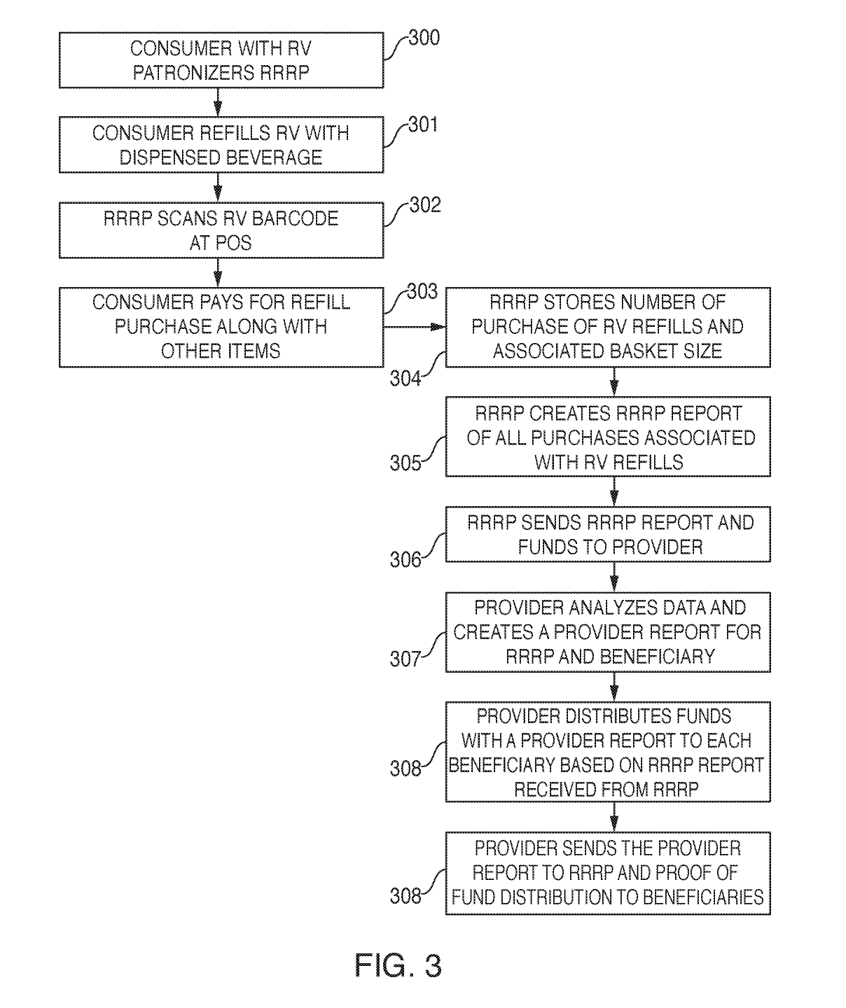

An embodiment of the present invention as described in FIG. 3 provides the following steps describing the consumer engagement with the RRRP, including tracking and disbursement of funds in accordance with the present invention: consumer with a refill vessel (RV) patronizes a registered retail refill partner (RRRP) (300); the consumer refills the RV with dispensed beverages (301); the RRRP scans the RV UPC/EAN at point of service (302); the consumer pays for the refill purchase, as well as for any other additional purchases (303); the RRRP stores the number of purchases of RV refills and additional purchases purchased at the same time as refill (304); the RRRP creates a RRRP report of all purchases associated with the RV refills (305); the RRRP sends the RRRP report and funds to provider (306); the provider analyzes the data and creates a provider report for RRRP and beneficiary (307); the provider distributes funds with the provider report to each beneficiary based on the RRRP report received from RRRP (308); and the provider sends the RRRP a copy of the provider report and proof of fund distribution to beneficiary (309).

Although the invention has been explained in relation to its preferred embodiment, it is to be understood that many other possible modifications and variations can be made without departing from the spirit and scope of the invention.

What is claimed is:

1. A method of providing funds to a beneficiary comprising the following steps:
a) distributing a refillable vessel to a consumer, wherein the refillable vessel comprises a machine readable label;
b) contracting between a third party provider and a retail store creating a registered retail refill partner wherein the registered retail refill partner provides refills of the refillable vessel at a set cost when a consumer fills the refillable vessel at the registered retail refill partner, wherein the set cost comprises fees the registered retail refill partner collects for the refill and funds for a beneficiary;
c) filling the refillable vessel at the registered retail refill partner;
d) reading the machine readable label on the refillable vessel at the registered retail refill partner;
e) collecting the set cost of the refill from the consumer;
f) providing information comprising the purchase of the refill and the funds for the beneficiary to the third party provider; and
g) distributing the funds for the beneficiary to the beneficiary.

2. The method according to claim 1, wherein the beneficiary is a charitable organization, a school, a not-for-profit, or a religious organization.

3. The method according to claim 1, wherein the machine readable label comprises a unique UPC, a barcode or an EAN that identifies the beneficiary.

4. The method according to claim 1, wherein the consumer chooses the design of the refillable vessel.

5. The method according to claim 1, wherein the consumer has an option to contribute additional funds to the beneficiary.

6. The method according to claim 1, wherein the refillable vessel is designed to hold cold beverages.

7. The method according to claim 1, wherein the refillable vessel is designed to hold hot beverages.

8. The method according to claim 1, wherein the refillable vessel is semi-disposable.

9. The method according to claim 1, wherein the refillable vessel is disposable.

10. The method according to claim 1, wherein the beneficiary distributes the refillable vessel to consumers.

11. The method according to claim 10, wherein the beneficiary provides the refillable vessel to the consumer at no cost.

12. The method according to claim 10, wherein the beneficiary sells the refillable vessel to the consumer.

13. The method according to claim 1, wherein the refillable vessel has more than one machine readable label.

14. A method of providing funds to a beneficiary comprising the following steps:
a) distributing a machine readable label to a consumer, wherein the machine readable label comprises machine readable information;
b) applying the machine readable label to a personal item;
c) contracting between a third party provider and a retail store creating a registered retail refill partner wherein the registered retail refill partner provides refills to the customer of a container at a set cost when a consumer fills the container at the registered retail refill partner, wherein the set cost comprises fees the registered retail refill partner collects for the refill and funds for a beneficiary;
d) filling the container at the registered retail refill partner;
e) reading the machine readable label on the personal item at the registered retail refill partner;
f) collecting the set cost of the refill from the consumer;
g) providing information comprising the purchase of the refill and the funds for the beneficiary to the third party provider; and
h) distributing the funds for the beneficiary to the beneficiary.

15. The method according to claim 14, wherein the consumer distributes additional machine readable labels to other consumers.

16. The method according to claim 14, wherein the machine readable label is a replacement for a previously supplied machine readable label.

17. The method according to claim 14, wherein the personal item is a refillable vessel, an identification card, a phone, or key chain attachment.

18. A method of providing funds to a beneficiary comprising the following steps:
a) contracting between a third party provider and a retail store creating a registered retail refill partner wherein the registered retail refill partner provides refills of a refillable vessel at a set cost when a consumer fills the refillable vessel at the registered retail refill partner, wherein the set cost comprises fees the registered retail refill partner collects for the refill and funds for a beneficiary;
b) providing an application for mobile devices that displays machine readable information, wherein the machine readable information identifies the set cost of the refill and the beneficiary to which the funds for the beneficiary will be transferred;
c) filling the refillable vessel at the registered retail refill partner;
d) reading the machine readable information from the mobile device at the registered retail refill partner;
e) collecting the set cost of the refill from the consumer;
f) providing information comprising the purchase of the refill and the funds for the beneficiary to the third party provider; and
g) distributing the funds for the beneficiary to the beneficiary.

19. A refillable vessel designed to provide funds to a beneficiary wherein:
a) the refillable vessel comprises a machine readable label;
b) a third party provider contracts with a retail store creating a registered retail refill partner wherein the registered retail refill partner provides refills of the refillable vessel at a set cost when a consumer fills the refillable vessel at the registered retail refill partner, wherein the set cost comprises fees the registered retail refill partner collects for the refill and funds for a beneficiary;
c) the refillable vessel is filled at the registered retail refill partner;
d) the machine readable label on the refillable vessel is read at the registered retail refill partner;
e) the set cost of the refill is collected from the consumer;
f) information is provided comprising the purchase of the refill and the funds for the beneficiary to the third party provider; and
g) the funds for the beneficiary are distributed to the beneficiary.
